(19) United States
(12) Patent Application Publication
(10) Pub. No.: US 2003/0150073 A1
(43) Pub. Date: Aug. 14, 2003

(54) Grip for makeup brush and method of manufacturing the same

(76) Inventor: Ki-Hong Jang, Seoul (KR)

Correspondence Address: ALAN H. LEVINE, HOWARD F. MANDELBAUM, LEVINE & MANDELBAUM, 444 MADISON AVENUE, 35TH FLOOR, NEW YORK, NY, 10022, US

(21) Appl. No.: 10/202,811

(22) Filed: Jul. 25, 2002

(30) Foreign Application Priority Data
Feb. 14, 2002 (KR) 10-2002-7855

(51) Int. Cl. B25G 1/00

(52) U.S. Cl. 15/143.1

(57) ABSTRACT

A grip for a makeup brush having the grip, hair and a combining unit includes a synthetic resin core inside and a brilliant transparent resin layer on an outer surface of the core, and manufactured through the steps of molding a core by pouring core melt containing resin and pigment into a core mold and removing the core mold after coagulation; molding a grip by pouring transparent resin melt into a grip mold with the molded core fixed at the center of the grip mold and removing the grip mold after coagulation; cutting an outer surface of the molded grip smooth and cutting an end of the grip, which is combined with a combining unit, to have a rough surface with a reduced diameter by a lathe; and polishing the outer surface of the cut grip by using a sandpaper. This grip has better appearance and improved durability.

### BACKGROUND OF THE INVENTION

1. Field of the Invention

The present invention relates to a brush grip, and more particularly to a grip for a makeup brush having beauty appearance and made of synthetic resin with good strength and its manufacturing method.

2. Description of the Related Art

Generally, a makeup brush includes a grip 2, hair 4 and a combining unit 3 for fixing the grip 2 and the hair 4, as shown in FIG. 1.

The grip 2 of such a makeup brush 1 is generally made of wood, and its surface is coated and then a trademark or specification is printed or carved thereon.

Thus, the wooden makeup brush grips 1 commonly have a stereotyped design with no difference to other products, so they does not follow up the taste of young customers who prefer novel designs.

In addition, the wooden grip can be easily broken down from exterior impacts.

### SUMMARY OF THE INVENTION

Therefore, the present invention is designed to overcome the problems of the prior art, and it is an object of the present invention to provide a grip for a makeup brush with good strength and beauty appearance.

In order to accomplish the above object, the present invention provides a grip for a makeup brush having the grip, the hair and a combining unit thereof, which includes a core made of synthetic resin and included in the grip and a brilliant transparent resin layer formed on an outer surface of the core.

Another object of the present invention is to provide a method of manufacturing such a grip for a makeup brush.

In order to obtain the above object, there is provided a method of manufacturing a grip for a makeup brush, which includes comprising the 3 steps of molding a core by pouring core melt containing resin and pigment into a core mold and then removing the core mold after the core melt is coagulated; molding a grip by pouring transparent resin melt into a grip mold with the molded core fixed at the center of the grip mold and then removing the grip mold after the resin melt is coagulated; cutting an outer surface of the molded grip smooth and cutting an end of the grip, which is to be combined with a combining unit, to have a rough surface with a reduced diameter by using a lathe; and polishing the outer surface of the cut grip by using a sand paper.

### BRIEF DESCRIPTION OF THE DRAWINGS

Other objects and aspects of the present invention will become apparent from the following description of embodiments with reference to the accompanying drawing in which:

FIG. 1 is a perspective view showing a conventional makeup brush;

FIG. 2 is a perspective view showing a makeup brush according to the present invention;

FIG. 3 is a flow chart for illustrating the process of making a grip of the makeup brush according to the present invention;

FIG. 4 is a flow chart for illustrating the process of molding a core;

FIG. 5 is a perspective view showing the core;

FIG. 6 is a flow chart for illustrating the molding process of the grip;

FIG. 7 exemplarily shows the molding process of the grip;

FIG. 8 is a perspective view showing the molded grip;

FIG. 9 is a perspective view showing the finished grip; and

FIG. 10 is a sectional view showing the grip for the makeup brush according to the present invention.

### DESCRIPTION OF THE PREFERRED EMBODIMENT

Hereinafter, the present invention will be described in more detail referring to the drawings, and characteristics and advantages of the present invention will be more clearly understood with the following detailed description.

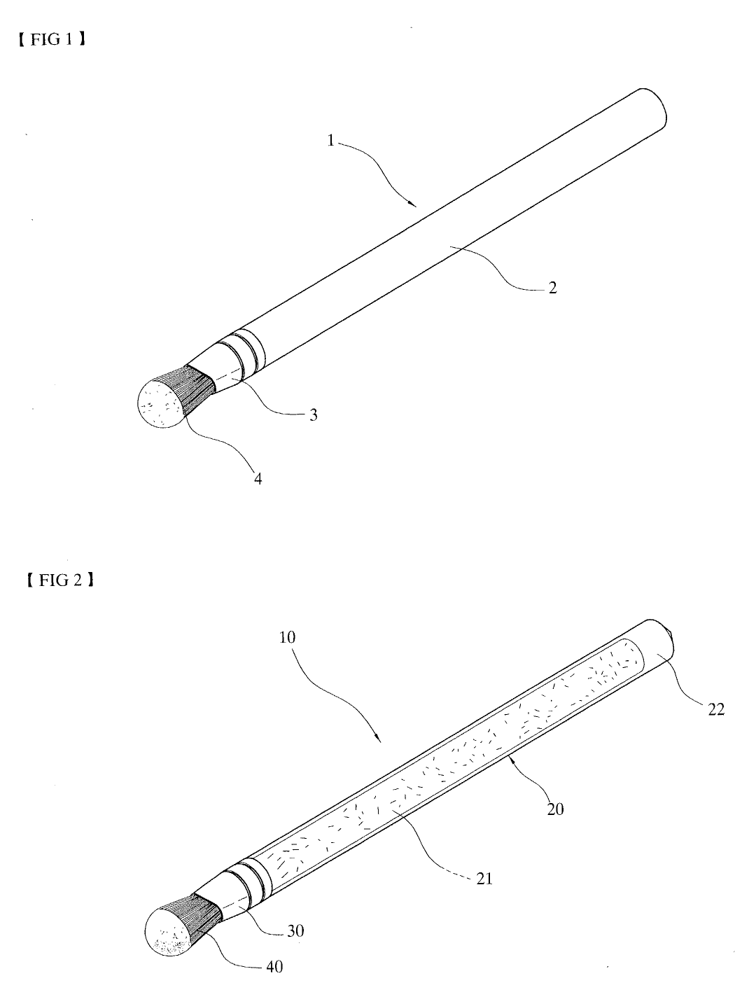

First, as shown in FIGS. 2, 9 and 10, a grip 20 for a makeup brush 10 according to the present invention includes a core 21 and a transparent resin layer 22.

The core 21 is made by molding resin mixed with a pigment to have a long circular bar shape and then included in the center of the grip 20 along a longitudinal direction of the grip 20. The resin used for molding the core 21 is preferably synthetic resin such as polyethylene and polypropylene.

The transparent resin layer 22 is formed at an outer surface of the core 21 as shown in the figures. This resin layer 22 is also made of polyethylene or polypropylene, and preferably the resin layer 22 is transparent so that the core 21 inside the grip 20 can be seen from outside. Also, the transparent resin layer 22 preferably has brilliance.

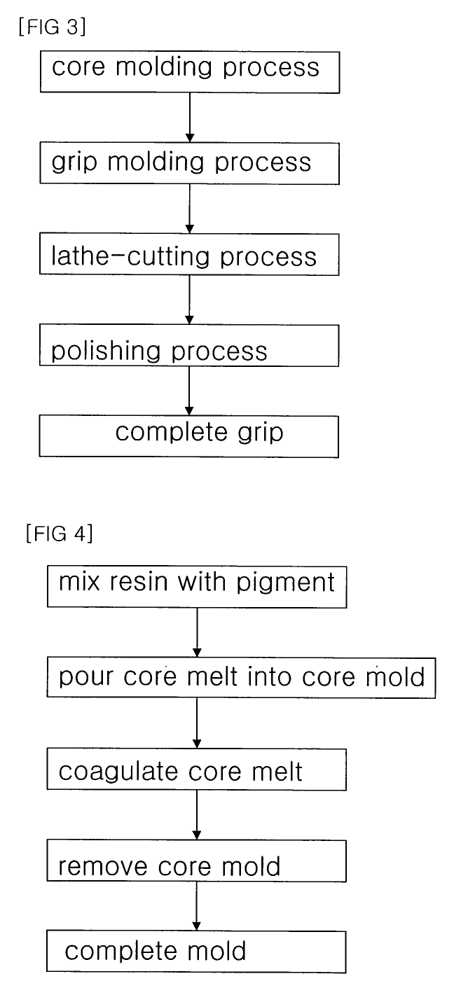

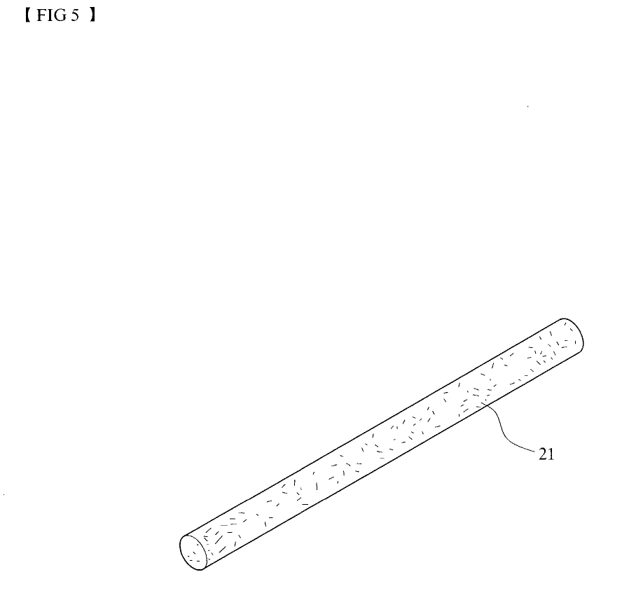

On the while, the present invention provides a method of manufacturing the grip 20 for a makeup brush 10 constructed as above, which includes a core molding process S100, a grip molding process S200, a lathe-cutting process S300, a polishing process S400 and complete the grip process S500 the product as shown in FIG. 3. This method is described below with reference to FIGS. 4 to 9.

First, in the core molding process S100 as shown in FIG. 4, resin is mixed with a pigment to make core melt S102. The mixed and melted core melt is poured into a long cylindrical hollow core mold S104, and then the core melt is coagulated in the core mold S106. If the core melt is coagulated, the core mold is removed S108, and then the core 21 having a long circular bar shape as shown in FIG. 5 is completely molded S110. At this time, the core 21 may have only one color, but the core 21 may also have unique and beautiful colors with at least two pigments mixed.

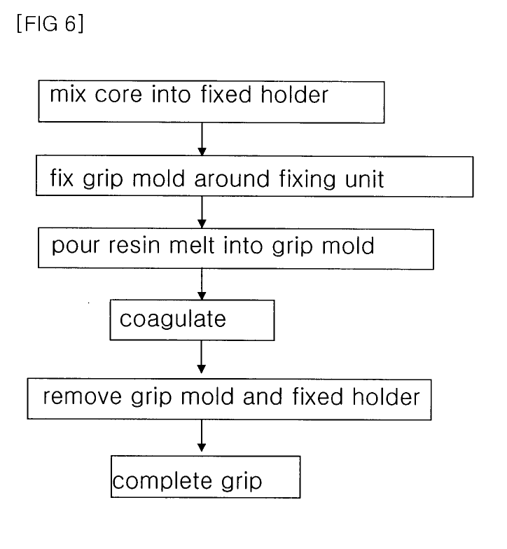

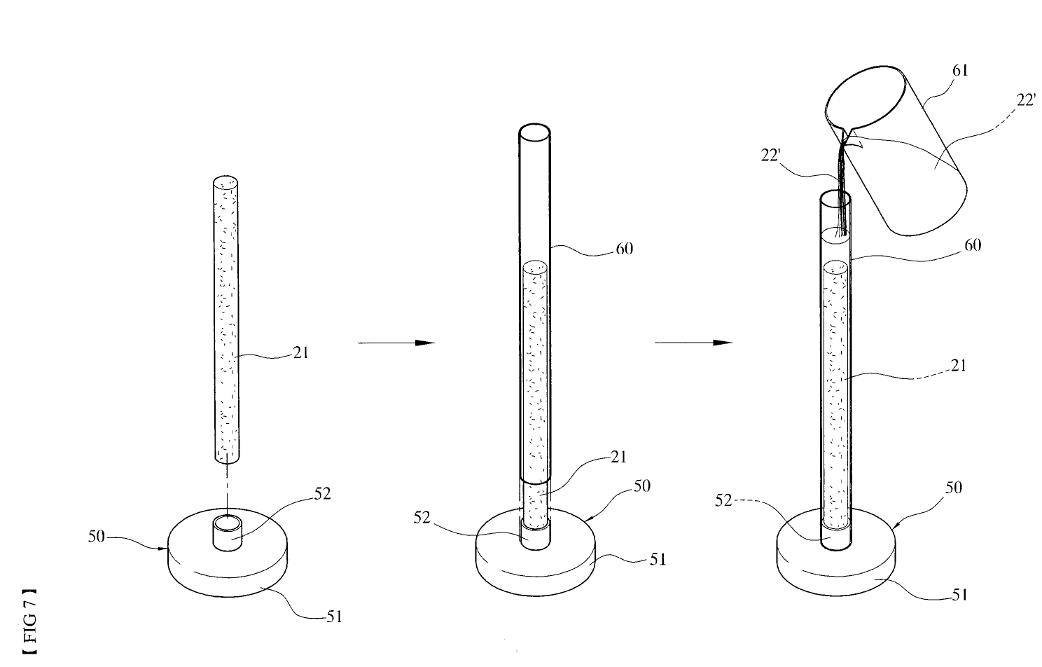

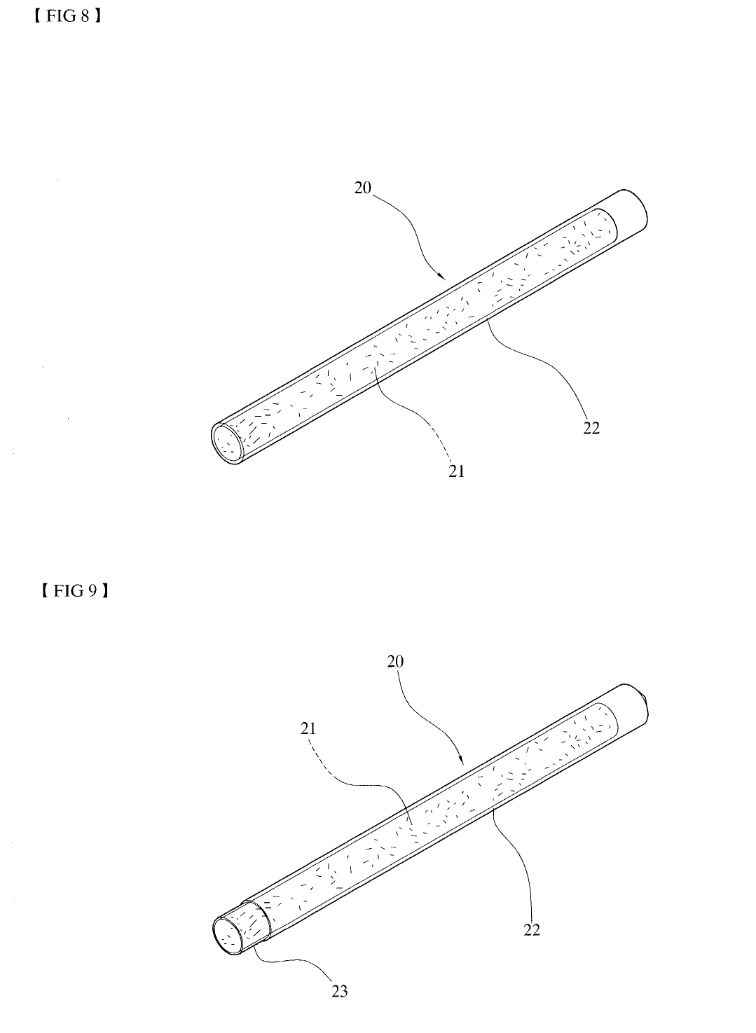

Then, in the grip molding process S200 as shown in FIGS. 6 and 7, the core 21 molded as above is fixed to an internal center of a grip mold 60, and then transparent resin melt 22′ is poured into the grip mold 60. Then, after the resin melt 22′ is coagulated, the grip mold 60 is removed and then the completed grip 20 is obtained. This transparent resin layer 22 is formed on an outer surface of the colored core 21 as shown in FIG. 8.

On the other hand, there can be suggested another way to mold the grip more easily. In this modified way, the grip molding process S200 is conducted using a fixed holder 50. The fixed holder 50 has a disk-type support 51 and a cylindrical hollow fixing unit 52 protruded from an upper center of the disk-type support 51, as shown in FIG. 7. Thus, during the grip molding process as shown in FIG. 7, an end of the molded core 21 is inserted and fixed into the fixing unit 52 of the fixed holder 50 S202. Then, an end of a long cylindrical hollow grip mold 60 is inserted and fixed around the fixing unit 52 S204. And then, the resin melt 22′ is poured into the grip mold 60 S206 and then coagulated S208. If the resin melt 22′ is completely coagulated, the grip mold 60 and the fixed holder 50 are removed S210 and the grip can be more easily molded S212. Reference numeral 61 denotes a beaker.

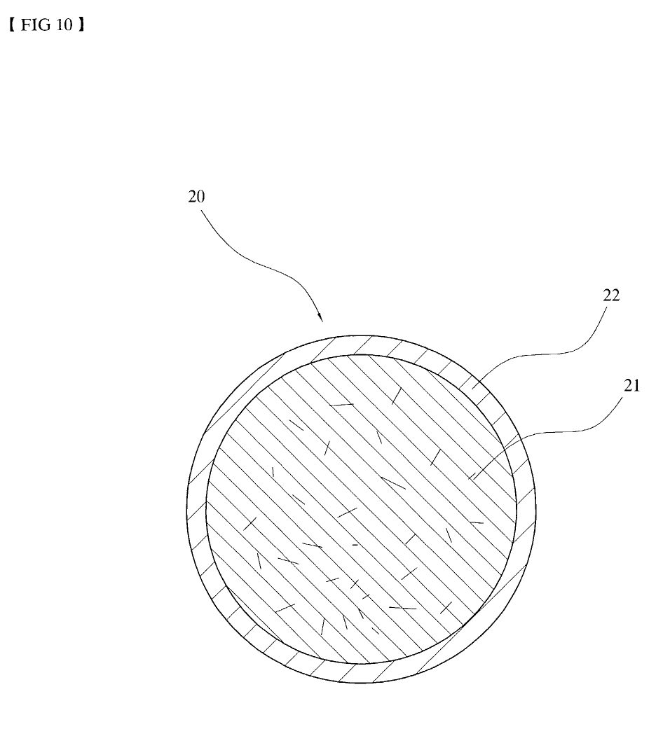

In the lathe-cutting process S300, a lathe cuts the grip 20 molded in the former process. This process is required for cutting an outer surface of the grip 20 smooth since the molded surface is generally rough and uneven. In addition to cutting the outer surface of the grip 20 smooth, the lathe-cutting process S200 also performs cutting a combining portion 23, at which a combining unit 30 for fixing the hair 40 and the grip 20 is combined and fixed, to have a rough surface with a reduced diameter. If the lathe-cutting process is completed, the grip 20 having a shape shown in FIG. 9 is obtained.

Finally, in the polishing process S400, the lathe-cut grip 20 is scrubbed with a sand paper to polish a surface of the grip 20. For such a polishing process, the sand paper polishes the outer surface of the grip 20 to have brilliance while the combining portion 23 of the grip 20 is engaged to a chuck and rotated at high speed.

Though not shown in the figures, the polished grip 20 is transferred to the process of assembling the hair 40 and the combining unit 30 through checking and testing processes, and then finally assembled to make the makeup brush 10 as shown in FIG. 2.

The grip 20 manufactured as above has beautiful and unique appearance and more suitable for the taste of the moderns who pursuit novelty and individuality, rather than the conventional makeup brush grip having a surface of a simple wooden design, since the grip 20 has a dual-type structure in which the core 21 having pretty colors is provided inside the grip 20 and the brilliant transparent resin layer 22 is formed on the surface of the core 21.

In addition, the grip 20 of the present invention has better durability in comparison to the conventional wooden grip since the grip 20 has a dual-type structure of the synthetic resin core 21 and the transparent resin layer 22.

### APPLICABILITY TO THE INDUSTRY

The present invention provides the grip for a makeup brush having more beautiful appearance and-better durability than the conventional one and its manufacturing method.

What is claimed is:

1. A grip for a makeup brush having the grip, the hair and a combining unit thereof, the grip comprising:
a core made of synthetic resin and included in the grip; and
a brilliant transparent resin layer formed on an outer surface of the core.

2. A method of manufacturing a grip for a makeup brush comprising the steps of:
molding a core by pouring core melt containing resin and pigment into a core mold and then removing the core mold after the core melt is coagulated;
molding a grip by pouring transparent resin melt into a grip mold with the molded core fixed at the center of the grip mold and then removing the grip mold after the resin melt is coagulated;
cutting an outer surface of the molded grip smooth and cutting an end of the grip, which is to be combined with a combining unit, to have a rough surface with a reduced diameter by using a lathe; and
polishing the outer surface of the cut grip by using a sand paper.
